(19) United States
(12) Patent Application Publication
(10) Pub. No.: US 2007/0211472 A1
(43) Pub. Date: Sep. 13, 2007

(54) Light guide module and optical mouse using the same

(75) Inventor: Liang-Yu Yao, Jhonghe City (TW)

Correspondence Address: RABIN & Berdo, PC, 1101 14TH STREET, NW, SUITE 500, WASHINGTON, DC, 20005, US

(73) Assignee: Darfon Electronics Corp., Taoyuan (TW)

(21) Appl. No.: 11/712,429

(22) Filed: Mar. 1, 2007

(30) Foreign Application Priority Data
Mar. 9, 2006 (TW) 95107987

(51) Int. Cl. F21V 7/00

(52) U.S. Cl. 362/297; 362/346

(57) ABSTRACT

A light guide module and an optical mouse using the same are provided. The optical mouse includes a light emitting apparatus and a light guide module. The light guide module includes a light guide body and a reflection member and is used for receiving a light beam generated by the light emitting apparatus. The light guide body includes a beam splitter for splitting the light beam into a first light beam and a second light beam. The reflection member is substantially parallel to the beam splitter. After reflected by the reflection member, the second light beam is substantially parallel to the first light beam.

This application claims the benefit of Taiwan application Serial No. 95107987, filed Mar. 9, 2006, the subject matter of which is incorporated herein by reference.

### BACKGROUND OF THE INVENTION

1. Field of the Invention

The invention relates in general to a light guide module and an optical mouse using the same, and more particularly to a light guide module with a reflection member for guiding two light beams split by a beam splitter toward a surface which an optical mouse is used on and an optical mouse using the same.

2. Description of the Related Art

Please referring to FIG. 1, part of a conventional optical mouse is illustrated in FIG. 1. The optical mouse 100 used on a surface S includes a light emitting apparatus 110, a light guide module 120 and a sensor 130. The light emitting apparatus 110, such as a light emitting diode (LED), is used for generating light. The light guide module 120 includes a convex lens surface 121, a reflection plane 122, a concave lens surface 123 and a beam splitter 124.

As shown in FIG. 1, light generated by the light emitting apparatus 110 is refracted by the convex lens surface 121 and then reflected by the reflection plane 122. After, the light is refracted by the concave lens surface 123 to form a parallel light beam emitted to the beam splitter 124. The beam splitter 124 is used for reflecting a portion of the light to the surface S. The portion of light is reflected by the surface S and then transmitted through the beam splitter 124 toward the sensor 130. A focusing element 131 of the sensor 130 focuses light on a sensing element 132 of the sensor 130. The focusing element 131 is a convex lens for example. The sensing element 132 senses the intensity of the light, and a processing unit calculates the displacement of the optical mouse 100 accordingly for determining the corresponding displacement of a cursor.

For example, the intensity ratio of the reflected beam and the transmitted beam is 15:85, and the ratio of effective light reflected by the surface S toward the beam splitter 124 is 50%. In other words, after the light refracted by the concave lens surface 123 is emitted to the beam splitter 124, 85% of the light (dotted arrow in FIG. 1) is transmitted thought the beam splitter 124 instead of transmitting to the surface S. As a result, the light reflected by the surface S toward the beam splitter 124 and then transmitted to the sensor 130 is only 6.375% (=15%×50%×85%) of the original light generated by the light emitting apparatus 110.

As stated above, most of the light is lost when transmitted through the beam splitter 124. Therefore, the utilization ratio of light energy of the light guide module 120 is low. The accuracy and friendliness of the cursor is affected greatly because the sensor 132 can not sense sufficient light. When a light emitting apparatus with higher power is applied to an optical mouse to solve this problem, the energy consumption of the optical mouse increases a lot, and the optical mouse is inefficient. Therefore, it is very important to design a light guide module with simple structure and better light utilization ratio.

### SUMMARY OF THE INVENTION

The invention is directed to a light guide module and an optical mouse using the same. A reflection member is used in the light guide module to reduce light loss due to light splitting. The light utilization ratio increases greatly, and the light intensity sensed by a sensor of the optical mouse increases effectively. Furthermore, the reflection member has simple structure so it is easy to dispose the reflection member.

According to the present invention, a light guide module applied to an optical mouse is provided. The optical mouse includes a light emitting apparatus and the light guide module. The light guide module includes a light guide body and a reflection member. The light guide body is used for receiving a light beam generated by the light emitting apparatus. The light guide body includes a beam splitter for splitting the light beam into a first light beam and a second light beam. The reflection member is substantially parallel to the beam splitter. After reflected by the reflection member, the second light beam is substantially parallel to the first light beam.

According to the present invention, an optical mouse used on a surface is provided. The optical mouse includes the light emitting apparatus, a light guide module and a sensor. The light guide module includes a light guide body and a reflection member. The light emitting apparatus is used for generating a light beam. The light guide body used for receiving the light beam includes a beam splitter. The beam splitter is used for splitting the light beam into a first light beam and a second light beam. The first light beam is emitted toward the surface. The reflection member is substantially parallel to the beam splitter. After reflected by the reflection member, the second light beam is substantially parallel to the first light beam and emitted toward the surface. The sensor is used for sensing a portion of the light beam reflected by the surface to determine the displacement of a cursor.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates part of a conventional optical mouse;

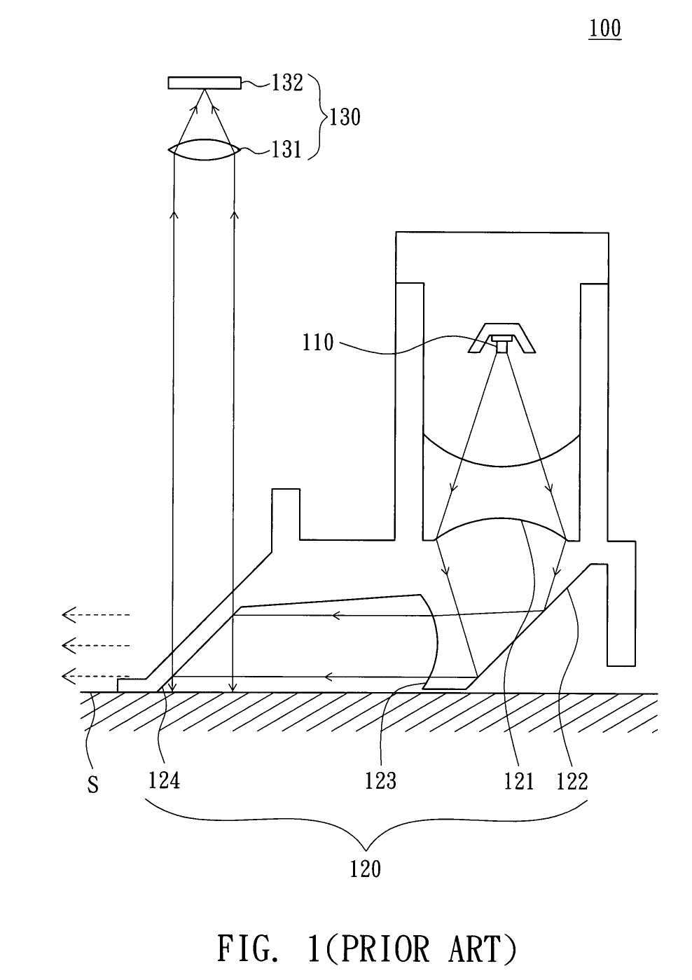

FIG. 2A illustrates a light guide module according to a first embodiment of the present invention;

FIG. 2B illustrates part of an optical mouse using a light guide module in FIG. 2A;

FIG. 3 shows a simplified light path in FIG. 2B;

FIG. 4 illustrates part of an optical mouse according to a second embodiment of the present invention;

FIG. 5 illustrates part of an optical mouse according to a third embodiment of the present invention;

FIG. 6 illustrates part of an optical mouse according to a fourth embodiment of the invention;

FIG. 7 illustrates part of an optical mouse according to a fifth embodiment of the present invention;

FIG. 8 illustrates part of an optical mouse according to a sixth embodiment of the present invention;

FIG. 9 illustrates part of an optical mouse according to a seventh embodiment of the present invention; and

FIG. 10 illustrates part of an optical mouse according to an eighth embodiment of the present invention.

### DETAILED DESCRIPTION OF THE INVENTION

Generally, a light emitting apparatus, such as a light emitting diode (LED), used in an optical mouse needs a light guide module for guiding light toward a surface which the optical mouse is used on. The light is reflected and scattered by the surface, and then the sensor senses the image corresponding to the surface. A reflection member is used in the present invention for increasing the light utilization ratio of the light guide module. Several embodiments are illustrated as follow accompanied with the drawings. However, the present invention is not limited thereto.

### First Embodiment

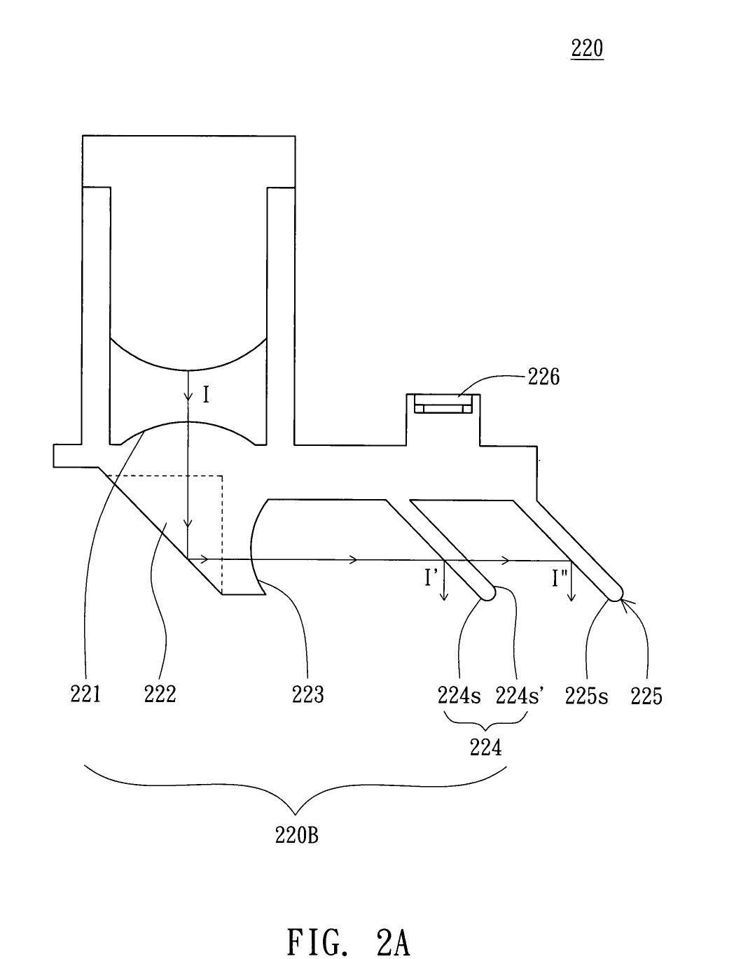

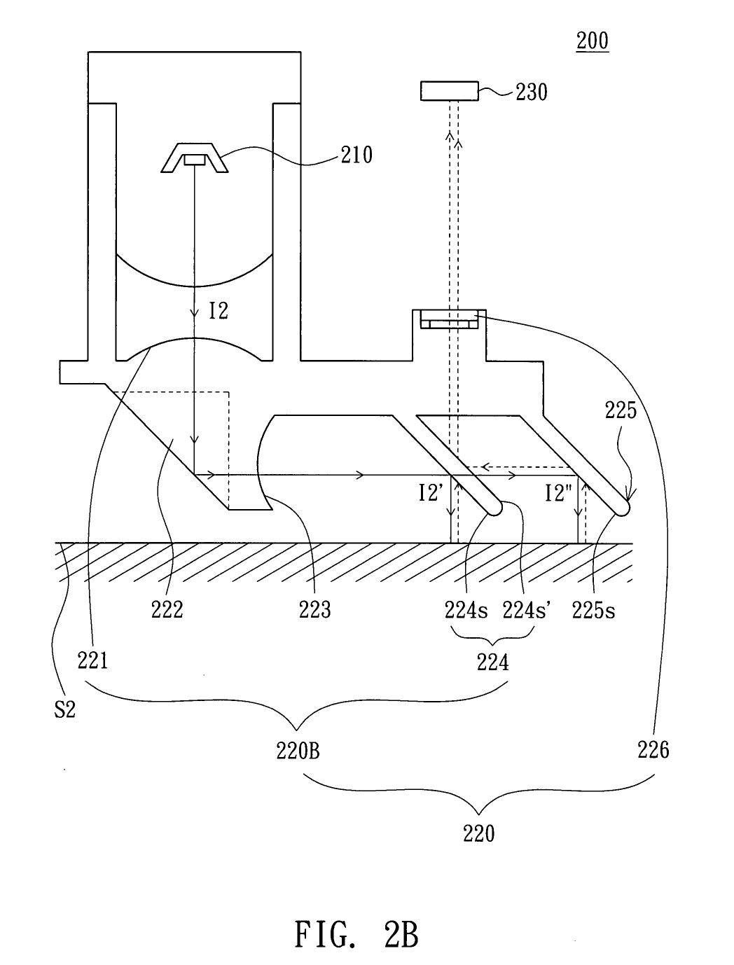

Please referring to FIG. 2A, a light guide module according to a first embodiment of the present invention is illustrated in FIG. 2A. The light guide module 220 includes a light guide body 220B and a reflection member 225. The light guide body 220B includes a beam splitter 224. In the present embodiment, the light guide body 220B further includes a convex lens surface 221, a concave lens surface 223 and a first reflection member 222 disposed between the convex lens surface 221 and the concave lens surface 223. Furthermore, the light guide module 220 further includes an aperture apparatus 226 adjacent to the beam splitter 224.

The reflection member 225 is a reflection mirror and substantially parallel to the beam splitter 224. The beam splitter 224 includes a first surface 224s and a second surface 224s' opposite to the first surface 224s. A reflection surface 225s of the reflection member 225 faces the second surface 224s′. The reflection surface 225s is coated with metal film or other reflection materials. The first reflection member 222 is a total reflection prism.

As shown in FIG. 2A, after the light guide body 220B receives a light beam I, the light beam I is refracted by the convex lens surface 221, reflected by the first reflection member 222 and refracted by the concave lens surface 223. Then, the light beam I is emitted toward the first surface 224s of the beam splitter 224. The beam splitter 224 splits the light beam I into a first light beam I′ and a second light beam I″. The first light beam I′ is reflected by the first surface 224s, and the second light beam I″ is transmitted through the second surface 224s′. Preferably, the angle between the first light beam I′ and the second light beam I′ is substantially equal to 90°. The reflection surface 225s of the reflection member 225 reflects the second beam I″, so that the second beam I″ is substantially parallel to the first beam I′.

The design of an optical mouse using the light guide module 220 is illustrated as follow accompanied with the drawings.

Please referring to FIG. 2B, part of an optical mouse using the light guide module 220 is illustrated in FIG. 2B. The optical mouse 220 used on a surface S2 further includes a light emitting apparatus 210 and a sensor 230. The light emitting apparatus 210 is adjacent to the first surface 224s, and the sensor 230 is adjacent to the second surface 224s′. The aperture apparatus 226 is disposed between the sensor 230 and the beam splitter 224. As shown in FIG. 2B, when the light guide module 220 receives a light beam I2 generated by the light emitting apparatus 210, the light beam I2 is guided by the light guide module 220, as shown in FIG. 2A. Then, the first light beam I2′ and the second light beam I2″ are split by the beam splitter 224. The first beam I2′ is emitted toward the surface S2. After reflected by the reflection member 225, the second light beam I2″ is emitted toward the surface S2 and parallel to the first light beam I2′. A portion of the second light beam I2″ is reflected by the surface S2 and then reflected by the reflection surface 225s and the second surface 224s' toward the aperture apparatus 226. After reflected by the surface S2, a portion of the first light beam I2′ is transmitted through the beam splitter 224 and emitted toward the aperture apparatus 226.

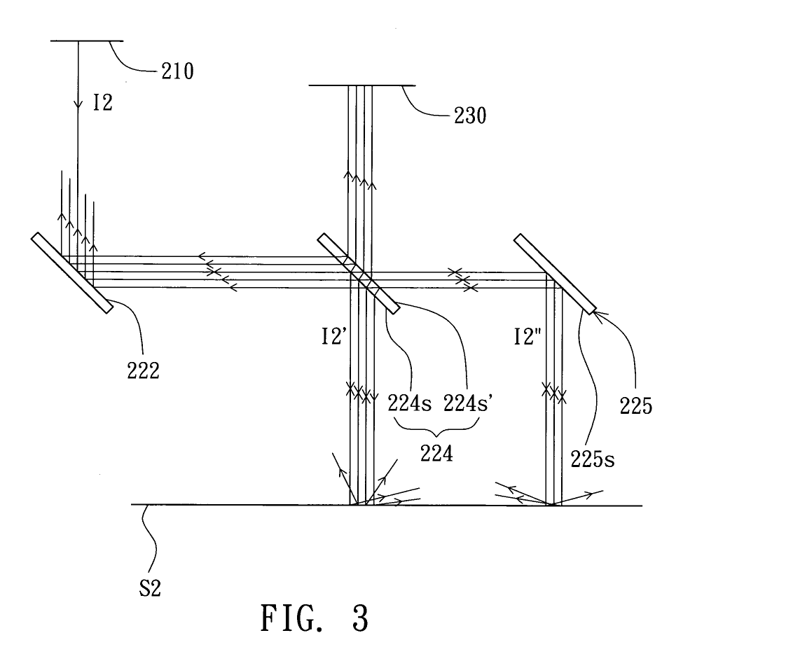

Please referring to FIG. 3, a simplified light path in FIG. 2B is illustrated in FIG. 3. The details of the structure are not shown in FIG. 3, and only the interfaces that the light beams contact are shown. As shown in FIG. 3, the reflection member 225 reuses the lost light due to light splitting (the second light beam I2″) for increasing the light utilization ratio. As a result, when the intensity ratio of the reflected beam and the transmitted beam of the beam splitter 224, and the ratio of effective light reflected by the surface S2 are the same as the conventional ones, the light emitted to the sensor 230 is about 12.75% [=15%×50%×85% (the portion of the first light beam I2′)+85%×50%×15% (the portion of the second light beam I2″)] of the light beam I2. In other words, the light utilization ratio is more than double the conventional one. The sensor 230 senses a portion of the light beam I2 after the portion of the light beam I2 is reflected by the surface S2 for determining the displacement of a cursor.

### Second Embodiment

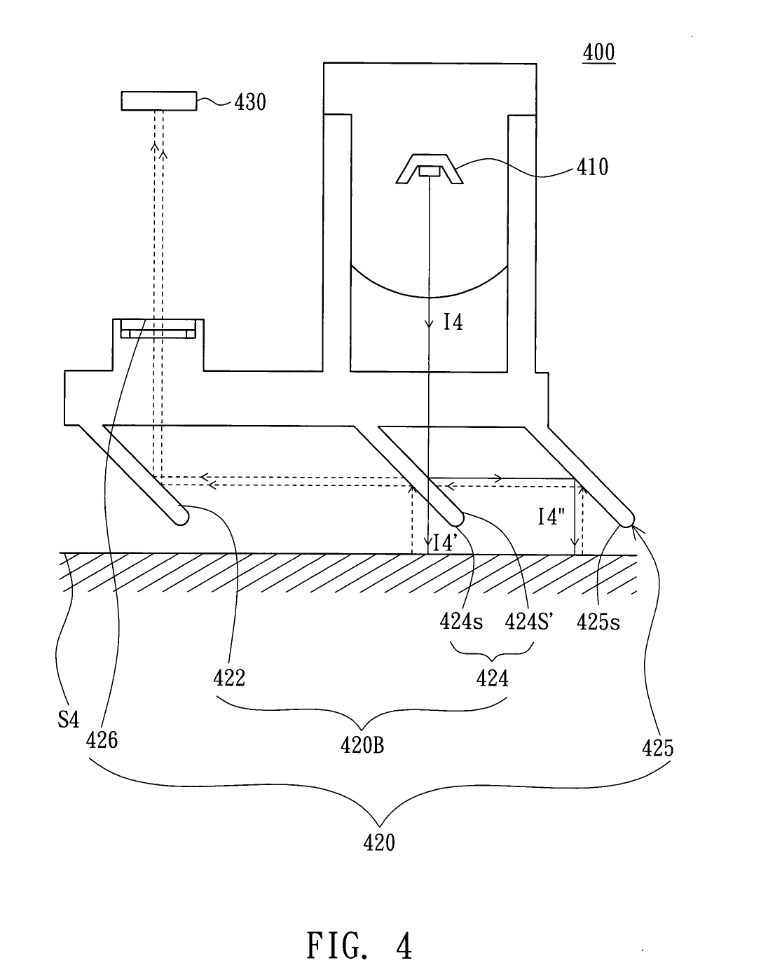

Please referring to FIG. 4, part of an optical mouse according to a second embodiment of the present invention is illustrated in FIG. 4. The difference between FIG. 4 and FIG. 2B is that the first reflection member 422 is a reflection mirror in the light guide module 420 of the optical mouse 400. Furthermore, the light emitting apparatus 410 is adjacent to the second surface 424s' of the beam splitter 424. The sensor 430 is adjacent to the first surface 424s of the beam splitter 424. Moreover, details of the light guide body 420B are not shown in FIG. 4.

As shown in FIG. 4, when the light guide module 420 receives the light beam I4 generated by the light emitting apparatus 410, the light beam I4 is emitted toward the second surface 424s′. Meanwhile, the beam splitter 424 splits the light beam I4 into a first light beam I4′ and a second light beam I4″. The first light beam I4′ is transmitted through the first surface 424s and then toward the surface S4. The second light beam I4″ is reflected by the second surface 424s' and emitted toward the reflection surface 425s of the reflection member 425. Preferably, the beam splitter 424 is disposed at a position so that an angle between the first light beam I4′ and the second light beam I4″ is substantially equal to 90°. After the reflection member 425 reflects the second light beam I4″ emitted toward the reflection surface 425s, the second light beam I4″ is substantially parallel to the first light beam I4′. A portion of the second light beam I4″ is reflected by the surface S4 and then reflected by the reflection surface 425s. Afterwards, the portion of the second light beam I4″ is transmitted through the beam splitter 424 and then reflected by the first reflection member 422 toward the aperture apparatus 426. After reflected by the surface S4, a portion of the first light beam I4′ is reflected by the first surface 424s and the first reflection member 422 toward the aperture apparatus 426.

When the intensity ratio of the reflected beam and the transmitted beam of the beam splitter 424, and the ratio of effective light reflected by the surface S4 are the same as the conventional ones, the light emitted to the sensor 430 is substantially 12.75% [=85%×50%×15% (the portion of the first light beam I4′)+15%×50%×85% (the portion of the second light beam I4″)] of the light beam I4. In other words, the light utilization ratio of the present embodiment is more than double the conventional one. The sensor 430 senses a portion of the light beam I4 reflected by the surface S4 for determining the displacement of the cursor.

### Third Embodiment

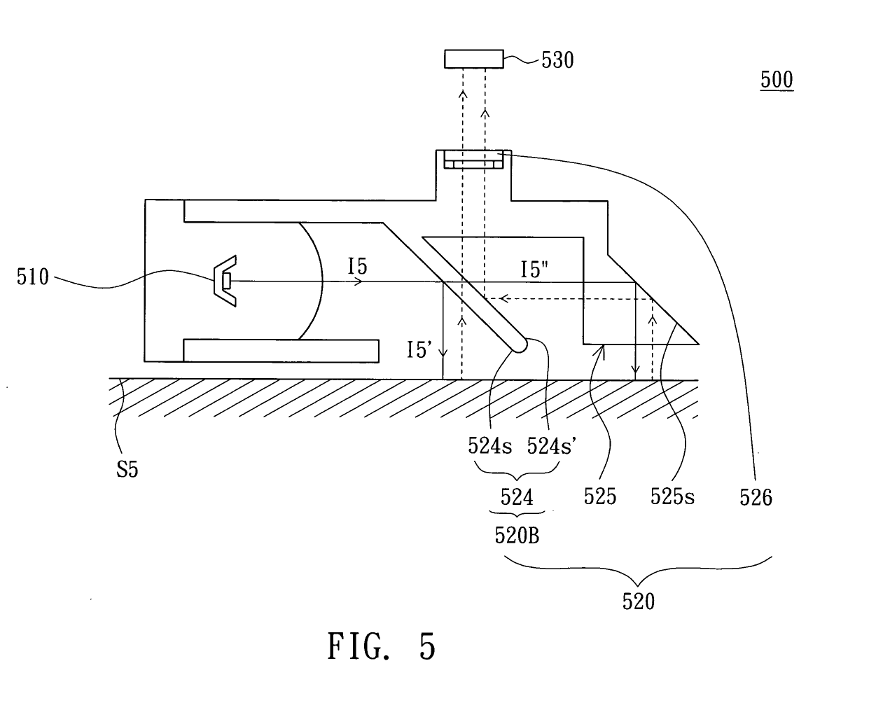

Please referring to FIG. 5, part of an optical mouse according to a third embodiment of the present invention is illustrated in FIG. 5. Details of the light guide body 520B are not shown in FIG. 5. The difference between FIG. 5 and FIG. 2B is that the first reflection member is not disposed in the light guide module 520 of the optical mouse 500. The light beam I5 generated by the light emitting apparatus 510 is emitted directly to the first surface 524s of the beam splitter 524. Furthermore, the reflection member 525 is a total reflection prism. As known from the above description, the light utilization ratio of the present embodiment is more than double the conventional one.

### Fourth Embodiment

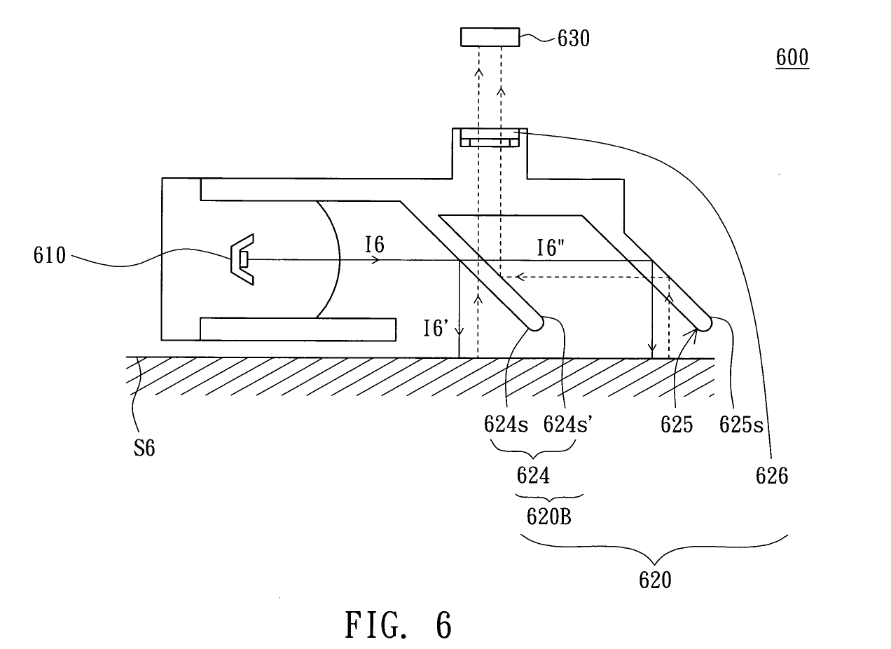

Please referring to FIG. 6, part of an optical mouse according to a fourth embodiment of the invention is illustrated in FIG. 6. Details of the light guide body 620B are not shown in FIG. 6. The difference between FIG. 6 and FIG. 5 is that the reflection member 625 of the light guide module 620 is a reflection mirror. As known from the above description, the light utilization ratio of the present embodiment is more than double the conventional one.

### Fifth Embodiment

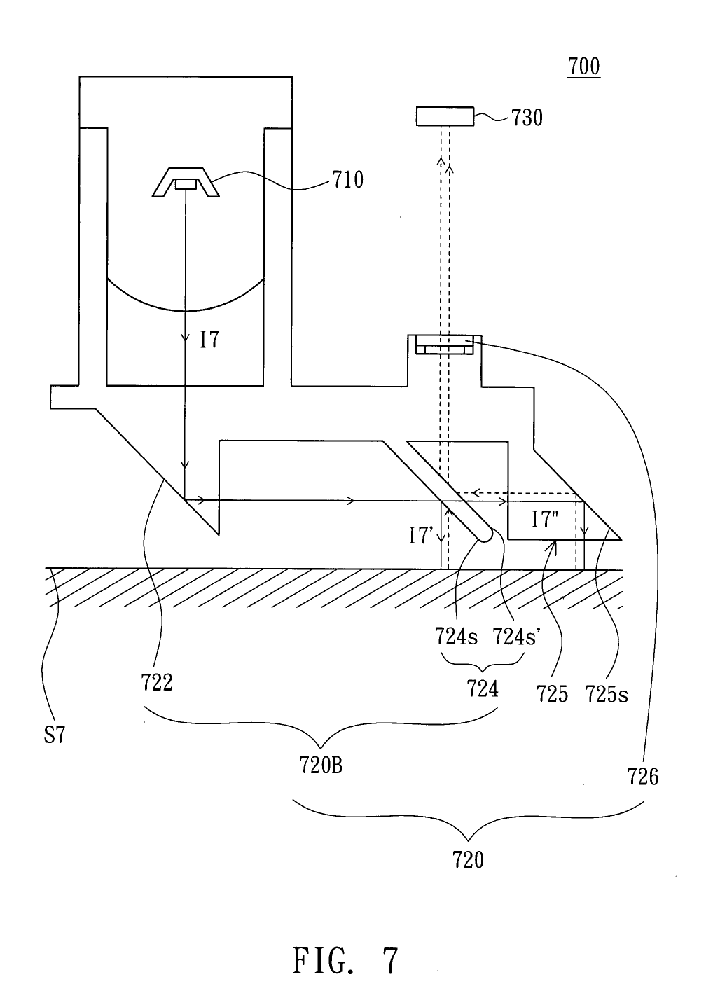

Please referring to FIG. 7, part of an optical mouse according to a fifth embodiment of the present invention is illustrated in FIG. 7. Details of the light guide body 720B are not shown in FIG. 7. The difference between FIG. 7 and FIG. 2B is that the reflection member 725 of the light guide module 720 is a total reflection prism. As known from the above description, the light utilization ratio of the present embodiment is more than double the conventional one.

### Sixth Embodiment

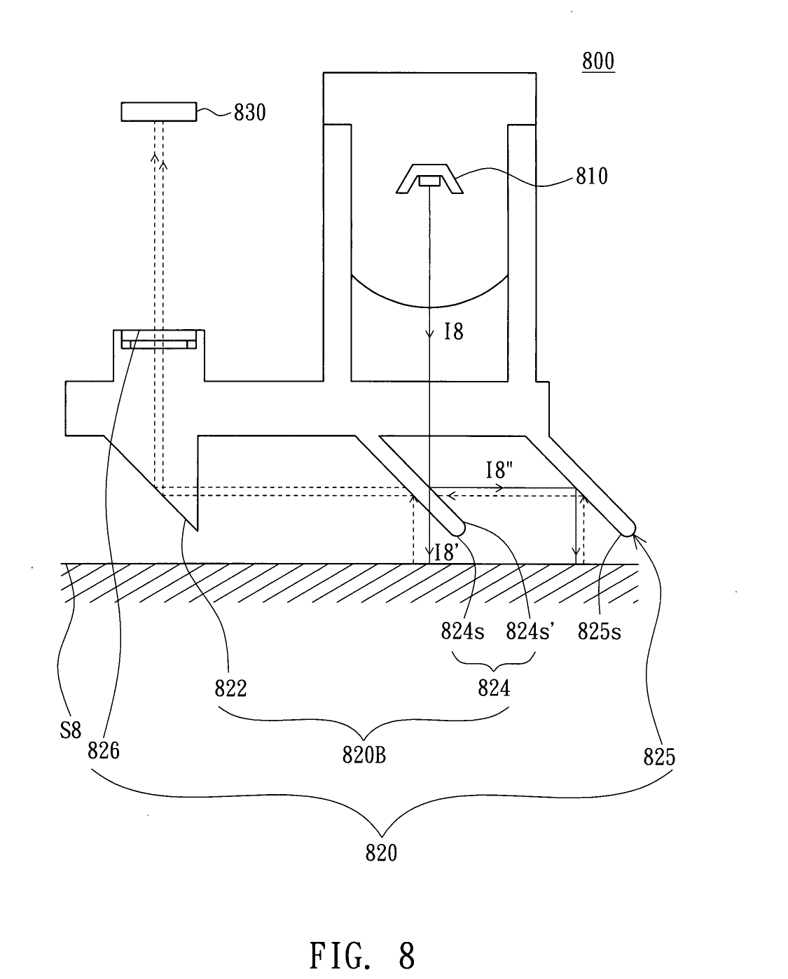

Please referring to FIG. 8, part of an optical mouse according to a sixth embodiment of the present invention is illustrated in FIG. 8. Details of the light guide body 820B are not shown in FIG. 8. The difference between FIG. 8 and FIG. 4 is that the first reflection member 822 is a total reflection prism in the light guide module 820 of the optical mouse 800. As known from the above description, the light utilization ratio of the present embodiment is more than double the conventional one.

### Seventh Embodiment

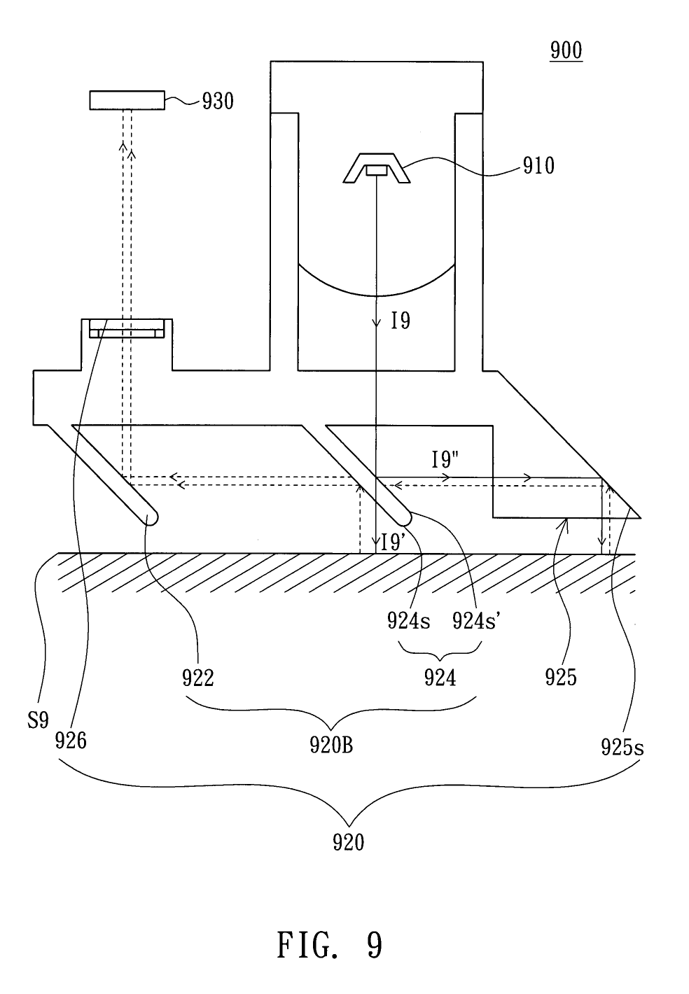

Please referring to FIG. 9, part of an optical mouse according to a seventh embodiment of the present invention is illustrated in FIG. 9. Details of the light guide body 920B are not shown in FIG. 9. The difference between FIG. 9 and FIG. 4 is that the reflection member 925 is a total reflection prism in the light guide module 920 of the optical mouse 900. As known from the above description, the light utilization ratio of the present embodiment is more than double the conventional one.

### Eighth Embodiment

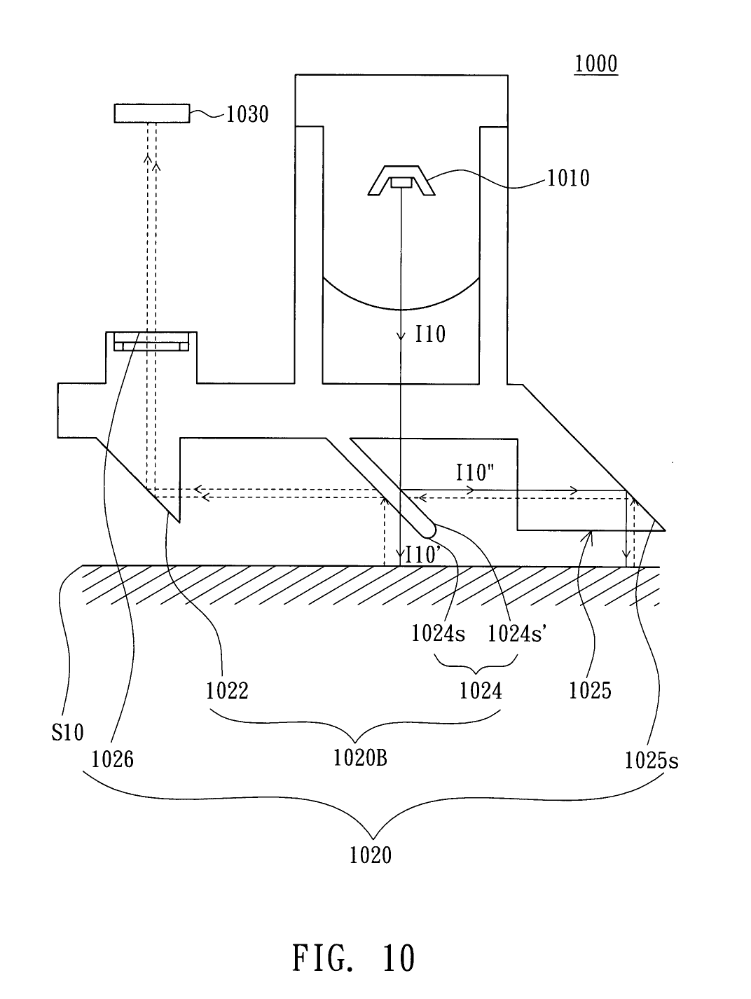

Please referring to FIG. 10, part of an optical mouse according to an eighth embodiment of the present invention is illustrated in FIG. 10. Details of the light guide body 1020B are not shown in FIG. 10. The difference between FIG. 10 and FIG. 9 is that the first reflection member 1022 is a total reflection prism in the light guide module 1020 of the optical mouse 1000. As known from the above description, the light utilization ratio of the present embodiment is more than double the conventional one.

Anyone who has ordinary skill in the field of the embodiments of the present invention can understand that the present invention is not limited thereto. For example, the reflection member and the first reflection member can be other reflective materials according to the needs. Also, the first reflection member can be disposed at another position according to the arrangement of the light emitting apparatus and the beam splitter. Or, the first reflection member does not have to be disposed in the light guide body, as in the third embodiment. Furthermore, when the light beam generated by the light emitting apparatus is emitted to the beam splitter at other angles, the angle between the first light beam and the second light beam is an acute angle. The locations of the beam splitter, the reflection member and the sensor can be adjusted accordingly for changing the light path to achieve the same guiding effect. Moreover, the reflection member does not have to cooperate with the light guide bodies described in the above embodiments. The intensity ratio of the reflected beam and the transmitted beam of the beam splitter and the structures of all the lenses can be adjusted according to manufacturing or operating factors. Also, the aperture apparatus and the sensor can increase depth of field or decrease lens flare according to the design to obtain a better image. As long as a reflection member is used in the light guide module of the optical mouse to guide the portion of the light beams separated by the beam splitter, such light guide module and the optical mouse using the same are encompassed by the present invention. The loss of light due to light splitting is reduced, so the light utilization ratio is increased.

In the light guide module and the optical mouse using the same revealed in the above embodiments of the present invention, the reflection member is used for reducing light loss due to light splitting by the beam splitter. The light utilization ratio increases greatly, and the light intensity that the sensor of the optical mouse senses increases effectively. Also, the reflection member has simple structure, so it is easy to dispose the reflection member. Furthermore, the light guide module of the present invention with higher light utilization ratio can cooperate with a light emitting apparatus with lower power for decreasing energy consumption of the optical mouse.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide module applied to an optical mouse with a light emitting apparatus, the light guide module comprising:
a light guide body for receiving a light beam generated by the light emitting apparatus, the light guide body comprising a beam splitter for splitting the light beam into a first light beam and a second light beam; and
a reflection member substantially parallel to the beam splitter, wherein the second light beam is substantially parallel to the first light beam after the second light beam is reflected by the reflection member.

2. The light guide module according to claim 1, wherein the beam splitter comprises a first surface and a second surface opposite to the first surface, the reflection member comprising a reflection surface, the light beam emitted to the first surface, the first light beam reflected by the first surface, the second light beam transmitted through the second surface, the reflection surface of the reflection member reflecting the second light beam.

3. The light guide module according to claim 2, wherein an angle between the first light beam and the second light beam is substantially equal to 90°.

4. The light guide module according to claim 1, wherein the beam splitter comprising a first surface and a second surface opposite to the first surface, the reflection member comprising a reflection surface, the light beam emitted to the second surface, the first light beam transmitted through the first surface, the second light beam reflected by the second surface, the reflection surface of the reflection member reflecting the second light beam.

5. The light guide module according to claim 4, wherein an angle between the first light beam and the second light beam is substantially equal to 90°.

6. The light guide module according to claim 1, wherein the reflection member is a total reflection prism or a reflection mirror.

7. An optical mouse used on a surface, the optical mouse comprising:
a light emitting apparatus for generating a light beam; and
a light guide module comprising:
a light guide body for receiving the light beam and comprising a beam splitter, the beam splitter used for splitting the light beam into a first light beam and a second light beam, the first light beam emitted to the surface; and
a reflection member substantially parallel to the beam splitter, wherein the second light beam is substantially parallel to the first light beam and emitted toward the surface after the second light beam is reflected by the reflection member; and
a sensor for sensing a portion of the light beam reflected by the surface to determine the displacement of a cursor.

8. The optical mouse according to claim 7, wherein the beam splitter comprising a first surface and a second surface opposite to the first surface, the reflection member comprising a reflection surface, the light beam emitted toward the first surface, the first light beam reflected by the first surface and then emitted toward the surface, the second light beam transmitted through the second surface and then emitted toward the reflection surface, the reflection surface of the reflection member reflecting the second light beam toward the surface.

9. The optical mouse according to claim 8, wherein an angle between the first light beam and the second light beam is substantially equal to 90°.

10. The optical mouse according to claim 8, wherein the light emitting apparatus is adjacent to the first surface, the sensor adjacent to the second surface, the light guide body further comprising a first reflection member for receiving the light beam and reflecting the light beam toward the first surface.

11. The optical mouse according to claim 10, wherein the first reflection member is a total reflection prism or a reflection mirror.

12. The optical mouse according to claim 7, wherein the beam splitter comprising a first surface and a second surface opposite to the first surface, the reflection member comprising a reflection surface, the light beam emitted toward the second surface, the first light beam transmitted through the first surface and then emitted toward the surface, the second light beam reflected by the second surface and then emitted toward the reflection surface, the reflection surface of the reflection member reflecting the second light beam toward the surface.

13. The optical mouse according to claim 12, wherein an angle between the first light beam and the second light beam is substantially equal to 90°.

14. The optical mouse according to claim 12, wherein the light emitting apparatus is adjacent to the second surface, the sensor adjacent to the first surface, the light guide body further comprising a first reflection member for receiving the portion of the light beam and reflecting the portion of the light beam toward the sensor.

15. The optical mouse according to claim 14, wherein the first reflection member is a total reflection prism or a reflection mirror.

16. The optical mouse according to claim 7, wherein the reflection member is a total reflection prism or a reflection mirror.

17. The optical mouse according to claim 7, wherein the light guide module further comprises an aperture apparatus disposed between the sensor and the beam splitter.
